(19) United States
(12) Patent Application Publication
(10) Pub. No.: US 2025/0039109 A1
(43) Pub. Date: Jan. 30, 2025

(54) WEIGHTED TRAFFIC DISTRIBUTION BETWEEN GRADED PORTS

(71) Applicant: MELLANOX TECHNOLOGIES, LTD., Yokneam (IL)

(72) Inventors: Eran Gil Beracha, Tel Aviv (IL); Liron Mula, Hertzliya (IL); Barak Gafni, Sunnyvale, CA (US); Gil Levy, Hod Hasharon (IL); Aviv Kfir, Nili (IL)

(21) Appl. No.: 18/225,562

(22) Filed: Jul. 24, 2023

(51) Int. Cl. H04L 49/9047; H04L 47/125; H04L 47/62

(52) U.S. Cl. CPC H04L 49/9047; H04L 47/125; H04L 47/623

(57) ABSTRACT

A system, a computing system, and a switch are provided. In one example, a system for routing data to one of a plurality of queues comprises a processor to poll a depth of one or more queues of the plurality of queues, determine a weight for each polled queue based on the depth of each polled queue, and route data received via a port to a first queue of the plurality of queues based on the determined weight for each polled queue.

### FIELD OF THE DISCLOSURE

The present disclosure is generally directed toward networking and, in particular, toward networking devices, switches, and methods of operating the same.

### BACKGROUND

Switches and similar network devices represent a core component of many communication, security, and computing networks. Switches are often used to connect multiple devices, device types, networks, and network types.

Devices including but not limited to personal computers, servers, or other types of computing devices, may be interconnected using network devices such as switches. These interconnected entities form a network that enables data communication and resource sharing among the nodes. Often, multiple potential paths for data flow may exist between any pair of devices. This feature, often referred to as multipath routing, allows data to traverse different routes from a source device to a destination device. Such a network design enhances the robustness and flexibility of data communication, as it provides alternatives in case of path failure, congestion, or other adverse conditions. Moreover, it facilitates load balancing across the network, optimizing the overall network performance and efficiency. However, managing multipath routing and ensuring optimal path selection can pose significant challenges, necessitating advanced mechanisms and algorithms for network control and data routing, and power consumption may be unnecessarily high, particularly during periods of low traffic.

### BRIEF SUMMARY

In accordance with one or more embodiments described herein, a computing system, such as a switch, may enable a diverse range of systems, such as switches, servers, personal computers, and other computing devices, to communicate across a network. Ports of the computing system may function as communication endpoints, allowing the computing system to manage multiple simultaneous network connections with one or more nodes.

Each port of the computing system may be associated with an egress queue of packets/data waiting to be sent via the port. In effect, each port may serve as an independent channel for data communication to and from the computing system. Packets to be sent via each port may be written to the queue associated with the port.

In the networking world, packets behave as queue elements and ports as a group of queues. Since queue occupancy for each port may vary as a function of time and traffic, some ports are a better choice for forwarding packets compared with others. In order to maintain optimal load balancing, it is desired to have equal queue depths between the queues in the system, therefore, a less occupied queue would be a better choice to enqueue compared with a more occupied one.

Round robin is a type of load balancer that helps spread queue elements between a group of queues. The weighted round robin is a load balancer that lets some queues get more queue elements compared with the rest, depending on some weight elements.

As described herein, traffic may be selectively sent via one or more particular ports of a computing system based on a number of factors. By assessing factors and altering weights of ports or queues, switching hardware of a computing system may be enabled to route traffic through the computing system in a most effective manner.

The present disclosure discusses a system and method for enabling a switch or other computing system to route traffic or data to queues based on a number of factors. Embodiments of the present disclosure aim to improve data flow efficiency and other issues by implementing an improved routing approach. The routing approach depicted and described herein may be applied to a switch, a router, or any other suitable type of networking device known or yet to be developed.

In an illustrative example, a device is disclosed that includes circuits to route data to one of a plurality of queues. The device includes a processor and is enabled to poll a depth of one or more queues of the plurality of queues, determine a weight for each polled queue based on the depth of each polled queue, and route data received via a port to a first queue of the plurality of queues based on the determined weight for each polled queue.

In another example, a system is disclosed that includes one or more circuits to determine an amount of data stored in each queue of a plurality of queues, determine a weight for each queue based on the data stored in each queue, and generate a routing instruction based on the determined weight for each queue, wherein data received by the computing system is routed to a first queue of the plurality of queues based on the routing instruction.

In yet another example, a switch is disclosed that includes one or more circuits to determine an amount of available space in each queue of a plurality of queues, determine a weight for each queue based on the amount of available space in each queue, and generate a routing instruction based on the determined weight for each queue, wherein data received by the switch is routed to a first queue of the plurality of queues based on the routing instruction.

Any of the above example aspects include wherein the depth of each polled queue is stored periodically in a database.

Any of the above example aspects include wherein each of the one or more queues of the plurality of queues is associated with an egress port.

Any of the above example aspects include wherein the depth is polled periodically or continuously.

Any of the above example aspects include assigning each polled queue a grade based on one of a percentage or an amount of occupied or available space of each respective queue, and wherein determining the weight for each polled queue is based on the assigned grade of the respective queue.

Any of the above example aspects include wherein the weight is determined further based on a size of each polled queue.

Any of the above example aspects include wherein the data is a packet received from one or more ingress ports.

Any of the above example aspects include wherein the system comprises a switch, and wherein routing the data comprises balancing traffic of the switch by routing the packet from one of the ingress ports to the first queue based on the determined weight for each polled queue.

Any of the above example aspects include the use of a counter, wherein the counter is used to determine how many bytes are sent to each port.

Any of the above example aspects include wherein routing the data to the first queue is further based on a value of the counter.

Any of the above example aspects include updating the weight for the one or more queues based on the value of the counter.

Any of the above example aspects include routing the data to the first queue is further based on a score associated with remote link failures.

Any of the above example aspects include wherein the score associated with remote link failures is determined based on data received from a remote peer.

Any of the above example aspects include wherein the data received from the remote peer indicates a quality associated with a queue associated with a destination of the data.

Any of the above example aspects include wherein routing the data to the first queue is based on the determined weight of each polled queue, a counter value indicating a size of previous data sent to each queue, and data from a remote peer indicating a quality associated with a remote link between the remote peer and a destination of the data.

Any of the above example aspects include averaging each of the determined weights for each queue, the counter value, and the data from the remote peer.

Any of the above example aspects include wherein the data is routed to the first queue by performing a round robin selection of the first queue based on grades associated with the determined weight for each queue.

Any of the above example aspects include wherein the data is routed to the first queue by randomly selecting the first queue based on grades associated with the determined weight for each queue.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a switch in accordance with at least some embodiments of the present disclosure;

FIG. 2 is a block diagram depicting an illustrative configuration of queues in accordance with at least some embodiments of the present disclosure;

FIG. 3 is a block diagram depicting an illustrative configuration of a computing network in accordance with at least some embodiments of the present disclosure;

FIG. 4 is a block diagram depicting an illustrative configuration of a switch receiving a packet in accordance with at least some embodiments of the present disclosure; and

FIG. 5 is a flowchart depicting an illustrative configuration of a method in accordance with at least some embodiments of the present disclosure.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

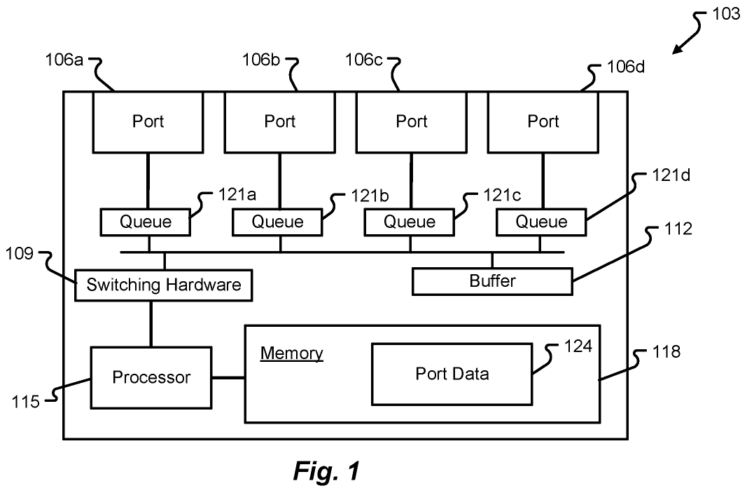

Referring now to FIGS. 1-5, various systems, and methods for routing packets between communication nodes will be described. The concepts of packet routing depicted and described herein can be applied to the routing of information from one computing device to another. The term packet as used herein should be construed to mean any suitable discrete amount of digitized information. The information being routed may be in the form of a single packet or multiple packets without departing from the scope of the present disclosure. Furthermore, it should be appreciated that the features and functions of a centralized architecture may be applied or used in a distributed architecture or vice versa.

In accordance with one or more embodiments described herein, a switch 103 as illustrated in FIG. 1 enables a diverse range of systems, such as switches, servers, personal computers, and other computing devices, to communicate across a network. While the computing device of FIG. 1 is described herein as a switch 103, it should be appreciated the computing device of FIG. 1 may be any computing device capable of sending data via ports 106a-d. Such a switch 103 as described herein may for example be a switch or any computing device comprising a plurality of ports 106a-d for connecting nodes on a network.

The ports 106a-d of the switch 103 may function as communication endpoints, allowing the switch 103 to manage multiple simultaneous network connections with one or more nodes. Each port 106a-d may be used to transmit data associated with one or more flows or communication sessions. Each port 106a-d may be associated with a queue 121a-d enabling the port 106a-d to handle outgoing data packets associated with flows.

Each port 106a-d of the computing system has an egress queue 121a-d which may store data such as packets waiting to be sent via the port 106a-d. In effect, each port 106a-d may serve as an independent channel for data communication to and from the switch 103. Ports 106 allow for concurrent network communications, enabling the switch 103 to engage in multiple data exchanges with different network nodes simultaneously. As a packet or other form of data becomes ready to be sent from the switch 103, the packet may be assigned or written to a queue 121 from which the packet will be sent by the port 106.

The ports 106a-d of the switch 103 may be physical connection points which allow network cables such as Ethernet cables to connect the switch 103 to one or more network nodes.

As described herein, data, such as packets, may be sent via a particular one or more of the ports 106a-d selectively based on a number of factors. Switching hardware 109 of the switch 103 may comprise an internal fabric or pathway within the switch 103 through which data travels between the ports 106a-d. The switching hardware 109 may in some embodiments comprise one or more network interface cards (NICs). In some embodiments, each port 106a-d may be associated with a different NIC. The NIC or NICs may comprise hardware and/or circuitry which may be used to transfer data between ports 106a-d and queues 121a-d.

Switching hardware 109 may also or alternatively comprise one or more application-specific integrated circuits (ASICs) to perform tasks such as determining to which port a received packet should be sent. The switching hardware 109 may comprise various components including, for example, port controllers that manage the operation of individual ports, network interface cards that facilitate data transmission, and internal data paths that direct the flow of data within the switch 103. The switching hardware 109 may also include memory elements to temporarily store data and management software to control the operation of the hardware. This configuration could enable the switching hardware 109 to accurately track port usage and provide data to the processor 115 upon request.

Packets received by the switch 103 may be placed in a buffer 112 until being placed in a queue 121a-d before being transmitted by a respective port 106a-d. The buffer 112 may effectively be an ingress queue where received data packets may temporarily be stored. As described herein, the port or ports 106a-d via which a given packet is to be sent may be determined based on a number of factors.

The switch 103 may also comprise a processor 115, such as a CPU, a microprocessor, or any circuit or device capable of reading instructions from memory 118 and performing actions. The processor 115 may execute software instructions to control operations of the switch 103.

The processor 115 may function as the central processing unit of the switch 103 and execute operative capabilities of the switch 103. The processor 115 may communicate with other components of the switch 103, such as switching hardware 109, such as to manage and perform computational operations.

The processor 115 may be configured to perform a wide range of computational tasks. Capabilities of the processor 115 may encompass executing program instructions, managing data within the system, and controlling the operation of other hardware components such as switching hardware 109. The processor 115 may be a single-core or multi-core processor and might include one or more processing units, depending on the specific design and requirements of the switch 103. The design of the processor 115 may allow for instruction execution, data processing, and overall system management, thereby enabling the switch 103's performance and utility in various applications. Furthermore, the processor 115 may be programmed or adapted to execute specific tasks and operations according to application requirements, thus potentially enhancing the versatility and adaptability of the switch 103.

The switch 103 may further comprise one or more memory 118 components. Memory 118 may be configured to communicate with the processor 115 of the switch 103. Communication between memory 118 and the processor 115 may enable various operations, including but not limited to, data exchange, command execution, and memory management. In accordance with implementations described herein, memory 118 may be used to store data, such as port data 124, relating to the usage of the ports 106a-d of the switch 103.

The memory 118 may be constituted by a variety of physical components, depending on specific type and design. Memory 118 may include one or more memory cells capable of storing data in the form of binary information. Such memory cells may be made up of transistors, capacitors, or other suitable electronic components depending on the memory type, such as dynamic random-access memory (DRAM), static random-access memory (SRAM), or flash memory. To enable data transfer and communication with other parts of the switch 103, memory 118 may also include data lines or buses, address lines, and control lines. Such physical components may collectively constitute the memory 118, contributing to its capacity to store and manage data, such as port data 124.

Port data 124, as which may be stored in memory 118, could encompass information about various aspects of port usage. Such information might include data about active connections, amount of data in queues 121, amount of data in the buffer 112, statuses of each port within the ports 106a-d, among other things. Port data 124 may include, for example, queue depths or occupancy, queue grades, distant link information, a number of total ports 106a-d, and a queue size or length for each queue 121a-d associated with each port 106a-d, as described in greater detail below. The stored port data 124 may be accessed and utilized by the processor 115 in managing port operations and network communications. For example, the processor 115 might utilize the port data 124 to manage network traffic by generating a queue vector mask which may be used by switching hardware 109 to direct data to queues 121a-d of the switch 103 as described in greater detail below. Therefore, the memory 118, in potential conjunction with the processor 115, may play a crucial role in optimizing the usage and performance of the ports 106 of the switch 103.

In one or more embodiments of the present disclosure, a processor 115 or switching hardware 109 of a switch 103 may execute polling operations to retrieve data relating to activity of the queues 121a-d, such as by polling the queues 121a-d, the buffer 112, the port data 124, the switching hardware 109, and/or other components of the switch 103 as described herein. As used herein, polling may involve the processor 115 periodically or continuously querying or requesting data from the switching hardware 109 or may involve the processor 115 or the switching hardware 109 periodically or continuously querying or requesting data from the queues 121a-d or from memory 118. The polling process may in some implementations encompass the processor 115 sending a request to the switching hardware 109 to retrieve desired data. Upon receiving the request, the switching hardware 109 may compile the requested queue data and send it back to the processor 115.

If a packet stored in the buffer 112 has a particular destination address, and multiple ports 106a-d lead to the destination address, the switching hardware 109 may be required to make a determination as to from which of the multiple ports 106a-d leading to the destination address the packet should be sent. Based on the determination as to from which of the multiple ports 106a-d leading to the destination address the packet should be sent, the switching hardware 109 may write the data of the packet to a respective queue 121a-d. For example, if a first port 106a and a second port 106b lead to the destination address of the packet, the switching hardware 109 may determine whether to write the packet to a first queue 121a associated with the first port 106a, a second queue 121b associated with the second port 106b, or both queues 121a-b.

The memory 118 may also store information about the queues 121a-d, the buffer 112, and/or other components, such as may be generated or determined by the switching hardware 109, the processor 115, or other components of the switch 103. Such information may be stored in the memory 118 as port data 124. Port data 124 may comprise, but should not be considered as limited to, depths of each of the queues 121a-d, weights for each queue, grades of each queue, an indication of which destination addresses are served by each port 106a-d, a size of each queue 121a-d, historical port data information, information about remote links, and/or any other information relating to the transfer of data to and from the switch 103 as described herein.

Port data 124 may include various metrics such as amount of data or a number of packets in each queue 121a-d, weighting information, queue grade information, and/or other information, such as data associated with other devices with which the switch 103 communicates. The processor 115, after receiving such data, might perform further operations based on the obtained information, such as optimizing port usage by determining queue weights and generating queue vector masks as described herein.

The processor 115 may also be capable of receiving information from remote peers such as other switches or devices. Such information may indicate a quality associated with a queue of the remote peer. For example, if a queue of a remote peer is congested or inactive, the remote peer can send information to the switch 103 indicating the queue is congested or inactive. The processor 115 may store such information and/or use such information to generating routing instructions for the switch 103.

The switch 103 may also be capable of generating information to share with remote peers to indicate to the remote peers a quality of each of the queues 121a-d, such as whether any one or more of the queues 121a-d are congested or inactive. After generating the information to share with remote peers, the information may be sent via one or more of the ports 106a-d to be received by one or more remote peers.

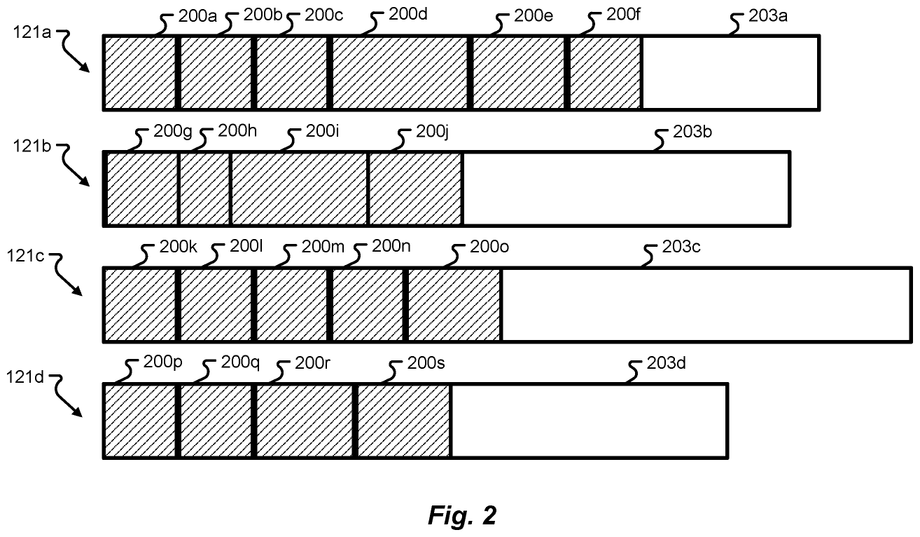

As illustrated in FIG. 2, each queue 121a-d may store packets 200a-s, or non-packetized data. The queues 121a-d may, as described above, be organized on a one-to-one basis with egress ports 106a-d and may operate as buffers collecting outgoing data before the data is dispatched via the respective port 106a-d. As should be appreciated, queued data may include network packets, frames, or data in any format.

The capacity of the queues 121a-d may vary in terms of the number of packets and the total data volume each queue 121a-d can hold. As should be appreciated, each queue 121a-d may be of a different capacity.

Available space 203a-d of a queue 121 may be an amount of storage space of the queue 121a-d which is not occupied by data waiting to be transmitted from an associated port. As such, the available space 203a-d of a queue 121 may be dependent upon an amount of data or number of packets 200a-s stored in the respective queue 121a-d.

As should be appreciated, each packet 200a-s may be a different size. Packet size, also referred to as packet length, can be defined as the total number of bytes that a packet contains, including the payload (data) and the header information. The size of packets may depend on several factors, including the type of data being transmitted, the protocols used in the network, and the specific network configuration or application requirements. As described herein, queue weightings may vary depending on the amount of data stored within each queue and/or a number of packets stored within each queue.

To execute the systems and methods in accordance with the embodiments described herein, a current depth may be polled for each queue 121a-d associated with an egress port 106a-d. In some implementations, the processor 115 of the switch 103 may poll the depth of each queue 121a-d on a periodic, continuous, or event-driven basis. The depth of a queue 121a-d may refer to a current volume of data in the queue 121a-d awaiting transmission. By polling the queue depth, the processor 115 may be enabled to make decisions on data handling, such as determining queue weightings and generating queue vector masks as described herein.

Polling a current depth of a queue 121a-d may comprise determining one or more of an amount of data stored in the queue 121a-d, a number of packets 200a-s stored in the queue 121a-d, an amount of available space 203a-d remaining in the queue 121a-d, and a percentage of occupied space in the queue 121a-d.

To poll the current depth of a queue 121a-d, in some implementations, a component of the switch 103, such as the switching hardware 109 or the processor 115 may read a register, a counter value, or a memory location. For example, the switching hardware 109 or the processor 115 may read a memory location in which packets in each queue are stored to determine a number of packets in each queue or read a memory location to determine an available space in each queue. In some implementations, the switching hardware 109 or the processor 115 may subtract the available space from the total size of the queue.

In some implementations, the processor 115 of the switch 103 may poll the current depth of each queue 121a-d by receiving data from switching hardware. For example, the switching hardware 109 may determine a current depth of each queue 121a-d by reading an amount of data in each queue, reading one or more counter values, or otherwise, and may send the current depth of each queue 121a-d to the processor 115. As another example, the processor 115 may be enabled to determine a current depth of each queue 121a-d by reading an amount of data in each queue, reading one or more counter values in the switching hardware 109, or otherwise.

In some implementations, polling the current depth of each queue 121a-d may comprise keeping track of a number and/or size of packets or data goes to each queue 121a-d. Keeping track of a number and/or size of packets or data which goes to each queue 121a-d may comprise using counters in the switching hardware 109 to count the number and/or size of data or packets being sent to each queue 121a-d. The counters may also in some implementations count or subtract a count as data or packets are sent out of each queue 121a-d by the associated port 106a-d. For example, a counter value may increase as packets or data is written to a queue 121a-d and may decrease as packets or data leaves the queue 121a-d.

The current depth may be polled periodically or continuously. Polling the current depth of each queue 121a-d may be performed, for example, on a time interval (e.g., milliseconds) or continuously. In some implementations, the current depth of each queue 121a-d may be updated with every packet written to the queue 121a-d or at intervals, such as every 100 packets or 100 bytes of data. As should be appreciated, many other possibilities for updating or polling the current depth of each queue may be implemented.

After determining the current depth of each queue 121a-d, the depth of each queue may be stored in a database, such as port data 124 in the memory 118 of the switch 103. The current depth of each queue 121a-d may be stored in the database periodically or may be continuously updated depending on the implementation. The current depth of the queues 121a-d may be stored as a vector or in a table in some implementations. For example, for a switch 103 with four egress ports 106a-d, a vector with four entries may be saved to memory, where each entry is an indication of the current depth of a respective queue 121a-d.

Based on the current depth of each queue, a grade for each queue (QueueGrade) may be determined. QueueGrade may be a quantization of a queue occupancy or depth (the current depth described above), quantizing the current depth of each queue to a number representing how full the respective queue is. As an example, a grade one may represent a queue depth of less than thirty kilobytes, a grade two may represent a queue depth greater than or equal to thirty kilobytes and less than sixty kilobytes, a grade three may represent a queue depth greater than or equal to sixty kilobytes and less than one hundred kilobytes, a grade four may represent a queue depth greater than or equal to one hundred kilobytes and less than one hundred-fifty kilobytes, and a grade five may represent a queue depth of greater than or equal to one-hundred-fifty kilobytes.

As described above, polling the queue depth may comprise determining a percentage or an amount of occupied or available space of each respective queue. In such an embodiment, each queue may be assigned a grade based on one of a percentage or an amount of occupied or available space of each respective queue. As an example, a grade one may represent a queue depth of less than twenty percent, a grade two may represent a queue depth greater than or equal to twenty percent and less than forty percent, a grade three may represent a queue depth greater than or equal to forty percent and less than sixty percent, a grade four may represent a queue depth greater than or equal to sixty percent and less than eighty percent, and a grade five may represent a queue depth of greater than or equal to eighty percent.

Determining the grade of each queue 121a-d may be performed in real time, or periodically, such as at intervals. For example, the queue depth of each queue 121a-d may be updated at the same rate or more often than the grade of each queue 121a-d is updated.

After determining the grade of each queue 121a-d, the grade of each queue 121a-d may be stored in a database, such as port data 124 in the memory 118 of the switch 103. The current grade of each queue 121a-d may be stored in the database periodically or may be continuously updated depending on the implementation. The grade of the queues 121a-d may be stored as a vector or in a table in some implementations. For example, for a switch 103 with four egress ports 106a-d, a vector with four entries may be saved to memory, where each entry is an indication of the current grade of a respective queue 121a-d.

For each grade, a weight (GradeWeight) may be determined. Each grade may be assigned a weight (GradeWeight). The GradeWeight of each grade may vary as a function of system settings. For example, a first grade, which may be assigned to queues with relatively low queue depths, may be assigned a higher GradeWeight while a fifth grade, which may be assigned to queues with the highest queue depths, may be assigned a lower GradeWeight.

Using the QueueGrade for each queue, a weight (AdjustedGradeWeight) for each

queue may be determined. Determining the AdjustedGradeWeight may be based on the assigned grade of the respective queue. Because the grade of a queue may be associated with a percentage or an amount of available space of the queue, the weight may effectively be determined based on a size of each queue.

Determining the AdjustedGradeWeight for a queue may be performed by assigning the GradeWeight to a queue based on the QueueGrade of the queue. For example, if a queue zero has a QueueGrade of grade one, and grade one has a GradeWeight of 50, then the AdjustedGradeWeight of queue zero may be determined to be 50. In this way, the processor 115, the switching hardware 109, or other component of the switch 103 may map the weight for each grade to each queue based on the grade of the respective queue.

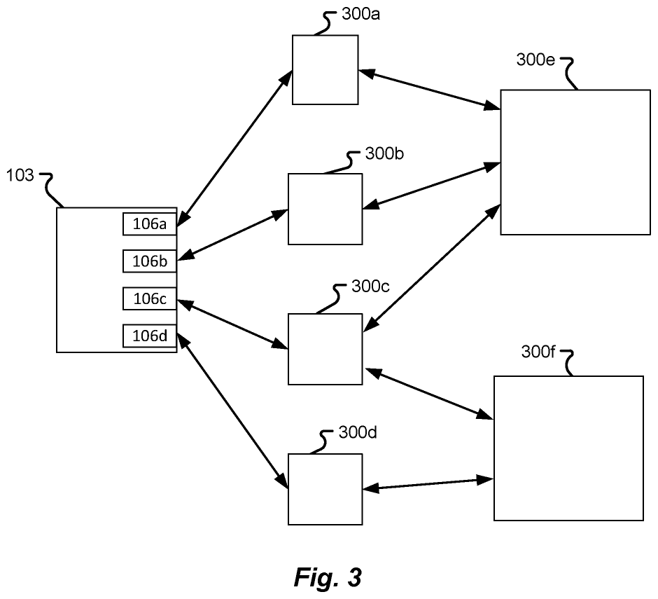

As illustrated in FIG. 3, a switch 103 may be connected to a number of nodes 300a-f, forming a network. For example, the systems and methods described herein may comprise a plurality of interconnected switches. Multiple switches 103, or other computing devices, can be interconnected in a variety of topologies, such as star, ring, or mesh, depending upon the specific requirements and resilience needed for the network. For instance, in a star topology, a plurality of switches may be connected to a central switch, whereas in a ring topology, each switch may be connected to two other switches in a closed loop. In a mesh topology, each switch may be interconnected with every other switch in the network. These robust structures afford a level of redundancy, as there are multiple paths for data to travel, ensuring that network functionality can be maintained even in the event of a switch failure.

Each node 300a-f may be a switch such as the switch 103 illustrated in FIG. 1 or any type of computing device. Each port 106a-d may be connected to the same or a different node 300a-d. In the example illustrated in FIG. 3, a first port 106a is connected to a first node 300a, a second port 106b is connected to a second node 300b, a third port 106c is connected to a third node 300c, and a fourth port 106d is connected to a fourth node 300d. A fifth node 300e is connected to the first, second, and third nodes 300a-c, and a sixth node 300f is connected to the third and fourth nodes 300c-d.

In order for a packet to travel from the switch 103 to the first node 300a, the packet must be sent via the first port 106a. In order for a packet to travel from the switch 103 to the second node 300b, the packet must be sent via the second port 106b. In order for a packet to travel from the switch 103 to the third node 300c, the packet must be sent via the third port 106c. In order for a packet to travel from the switch 103 to the fourth node 300d, the packet must be sent via the fourth port 106d. In order for a packet to travel from the switch 103 to the fifth node 300e, the packet must be sent via one or more of the first, second, and third ports 106a-c. The first, second, and third nodes 300a-c may be considered as hop switches for packets sent to the fifth node 300e. In order for a packet to travel from the switch 103 to the sixth node 300f, the packet must be sent via one or both of the third and fourth ports 106c-d. The third and fourth nodes 300c-d may be considered as hop switches for packets sent to the sixth node 300f. A packet with a destination address of the fifth node 300e may be sent via any of ports 106a-c while a packet with a destination address of the sixth node 300f may be sent via either the third or fourth port 106c-d. It should be appreciated that each of the arrows connecting the nodes 300a-d to nodes 300e-f may represent any number of one or more connections via one or more ports of each node 300a-f.

In some implementations, an additional weight (QueueWeight) may be determined for each queue. The QueueWeight of a queue may in some implementations be based on remote link failures. If the next hop switch has fewer available ports, the QueueWeight of queues leading to this next hop may be lower. For example, the first, second, and third nodes 300a-c may be considered as hop switches for the more distant fifth node 300e. If the second node 300b is congested or has fewer ports which lead to the fifth node 300e as compared to the first node 300a or the third node 300c, the second port 106b of the switch 103 may be assigned a lower weight than the first port 106a and the third port 106c. As a result, the switch 103 may be less likely to send a packet to the fifth node 300e via the second port 106b than via the first port 106a and the third port 106c.

The QueueWeight may be determined based on data received from a remote peer. For example, the switch 103 may receive information from one or more nodes 300a-f indicating a number of active queues, a level of congestion, or information about another quality associated with a queue of the remote peer which may be used by the switch 103 to assign a QueueWeight for ports leading to the respective node. The switch 103 may receive the information in the form of a packet or a message from each remote peer. The switch 103 may receive the packet or message from the remote peer via one of ports 106a-d as illustrated in FIG. 1, and the packet or message may be received and/or handled by the switching hardware 109 and/or the processor 115.

Data may be routed to queues based at least in part on data received from peers (e.g., the QueueWeight). Routing data to a particular queue may be based on a determined AdjustedGradeWeight of each queue (based on the GradeWeight and QueueGrade), a counter value indicating a size of past data sent to each queue, and a determined QueueWeight based on data from a remote peer indicating a quality associated with a remote link between the remote peer and a destination of the data being routed. In some implementations, each of the determined queue grade of each queue, the counter value, and the data from the remote peer may be averaged.

Using both the AdjustedGradeWeight and the QueueWeight for each queue, the switch 103 may determine a final queue weight (FinalQueueWeight) for each queue. The FinalQueueWeight may be a combination of the AdjustedGradeWeight and the QueueWeight. In some implementations, the FinalQueueWeight may be a ratio of the AdjustedGradeWeight and the QueueWeight or may be based only one of the AdjustedGradeWeight and the Queue Weight.

In some implementations, a formula may be used to calculate or determine the FinalQueueWeight. For example, a weighting ratio number (CR) may be determined to indicate whether AdjustedGradeWeight or the QueueWeight is more important in determining routing. CR may be a variable which adjusts which of QueueWeight or AdjustedGradeWeight is more heavily used to weight the routing.

The CR variable can be set arbitrarily, for example by a user, in order to give a relative weight to each of the QueueWeight and AdjustedGradeWeight when combining them to the FinalQueueWeight. The FinalQueueWeight may be the actual weighting that the switching hardware 109 may use when routing data. The formula may be, for example, FinalQueueWeight=CR*QueueWeight+(1−CR)*AdjustedGradeWeight.

As should be appreciated, if for a particular use case the QueueWeight is not to be used for routing, CR can be set to zero, or if the AdjustedGradeWeight is not to be used for routing, CR can be set to one. If, for a particular use case the QueueWeight is more important, CR can be set greater to 0.5, or if QueueWeight is less important, CR can be set to less than 0.5.

Once a FinalQueueWeight is determined for each queue, a weight vector of the queues may be generated. In some implementations, a different weight vector may be generated for each possible destination address and may include only queues for ports which lead to the destination address. For example, the weight vector may be set equal to ValidQueues*FinalQueueWeight or ValidQueues*[CR*QueueWeight+(1−CR)*AdjustedGradeWeight], where ValidQueues is a vector indicating all possible queues.

The FinalQueueWeight for each queue may be represented as four bits. The weight vector may only include entries for relevant ports, that is ports which are options for sending a packet/data. E.g., a vector for four ports, with a first port weighted 50%, second port 25%, third port 0%, fourth port 100% may be [0011] [0001] [0000] [1111].

As described above, the weights for each queue may be updated over time. Similarly, the weight vector may be updated. Updating the weight for one or more queues may be based on a size of the routed data. As data is routed into queues, the amount of data in the queues changes. Larger data sizes routed to a queue result in the queue containing more data. Because the weight for each queue is based at least in part on an amount of data in each queue, the size of the routed data affects the weight of each queue. As such, changes in the weight for each queue may be based on a size of routed data. By updating the weight of each queue as data is routed, either continuously or periodically, the size of the routed data can be taken into account.

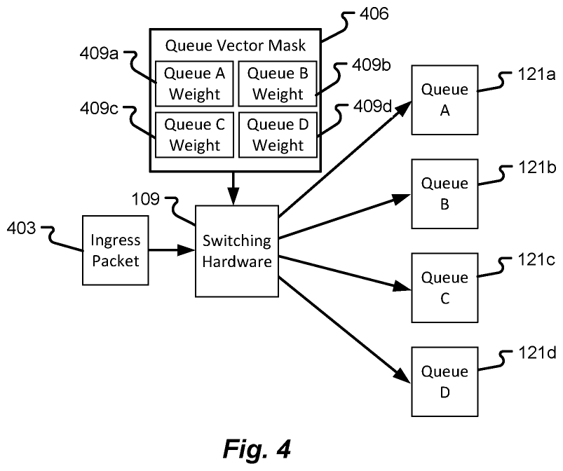

As illustrated in FIG. 4, switching hardware 109 may be configured to route a packet 403 to one or more queues 121a-d based on a weight 409a-d of each queue 121a-d. The switching hardware 109 and queues 121a-d may be as described above in relation to FIG. 1.

As described above, the switching hardware 109 may be any type of computing device capable of reading and writing data. The switching hardware 109 may be one or more circuits, a processor, an ASIC, or any computing device capable of performing packet routing as described herein.

The packet 403, while illustrated as being received by the switching hardware 109, may be read by the switching hardware 109 from memory 118, a buffer 112, or any memory location on or in communication with the switch. In some implementations, the switching hardware 109 may direct other components of the switch 103 in routing the ingress packet 403 to a queue 121a-d.

The switching hardware 109 may direct the ingress packet 403 to a queue 121a-d based on a weight 409a-d of each of the queues 121a-d. The weight 409a-d of each queue 121a-d, as described above may be calculated based on a current or recent queue depth, a grade of the queue, a weight of the grade, and external information such as remote link data. The calculated weight 409a-d of each queue 121a-d may be stored in the form of a queue vector mask 406. The queue vector mask 406 may be generated by the processor 115 and sent to the switching hardware 109 by the processor 115 or may be generated by the switching hardware 109.

Based on the weight 409a-d of each queue 121a-d, the switching hardware 109 may assign each packet to a queue. The assignment of packets to queues may be performed either in a weighted-random fashion or in a weighted round-robin fashion.

To implement a weighted round-robin assignment of packets to queues 121a-d, the queue vector mask 406 may represent each queue 121a-d by a multi-bit binary number (e.g., a queue may be represented by one of 0000, 0001, 0011, 0111, 1111).

As an example, if a first port 106a is weighted so as to not receive any additional packet, the first port 106a may be represented by a logical zero (0) in each bit of its multi-bit binary number. If each queue is represented by four bits, the first port 106a may be represented by 0000. As should be appreciated, a 0000 queue would not get a packet, and 1111 would be four-times likelier to get a packet as compared to 1000.

The switching hardware 109 may perform round-robin by writing a packet to a next logical one (1) in the queue vector mask 406. If the queue vector mask 406 for a switch with

four egress ports 106a-d is [0000] [0001] [0011] [0111], then the switching hardware 109 may perform round robin by routing a first packet to a second port 106b, second and third packets to a third port 106c, and fourth through sixth packets to a fourth port 106d.

In this way, the data is routed to the first queue by performing a round robin selection of the first queue based on weights associated with the determined queue grade of each queue.

In some embodiments, instead of assigning packets to queues using a round-robin methodology, the packets may be randomly assigned based on the weighting. For example, the switching hardware 109 may perform random assignment by writing a packet to a random logical one (1) in the queue vector mask 406.

After writing the packet 403 to one or more particular queues 121a-d, the switching hardware 109 may perform other steps, such as recording which queue 121a-d received the packet 403 and/or a size of the packet 403 routed to the queue 121a-d.

The switching hardware 109 may record the state of the last chosen index or queue in memory. That is, the switching hardware 109 may record which bit in the queue mask was last used to route a packet. As a result, when a timelapse occurs, the round-robin can continue from where it left off.

When routing packets of non-equal sizes, a potential issue that may occur is that effectively, the queue sizes will behave similar to random walk instead of round robin as each port may get different number of bytes. That is, even if a queue is getting fewer packets, if the queue randomly happens to get larger packets, the queue may be overloaded. In order to resolve this, a counter that counts how many bytes were sent to each port will be added, and the round robin decisions between the best grades will also take into account the number of bytes sent.

In some embodiments, the round robin may use a randomized starting index=when a round robin cycle completes, it can wrap around, but with a new starting index which may be chosen randomly. Because the weight 409a-d of each queue is affected by the size of the data sent to each queue, data may be routed to queues based at least in part on how many bytes have been sent to each port.

In some embodiments, a packet may be routed to a particular queue based at least in part on a size of the packet. For example, a larger packet may be sent to a queue with a larger weighting. In some implementations, thresholds may be used. If a packet exceeds a certain packet size, the switching hardware 109 may send the packet only to a queue with a weight greater than a particular threshold.

In some embodiments a counter may be used to determine how many bytes are sent to each queue. The counter may, as described above, be a part of the switching hardware 109. Upon determining which queue to write the packet to, the switching hardware 109 may increase a counter associated with the determined queue either by one or based on a size of the packet.

Routing future packets to a queue may be based on the counter. For example, the weighting of the queues may be updated based at least in part on the counters. Counter values may be read by the processor 115 to use to update the weightings.

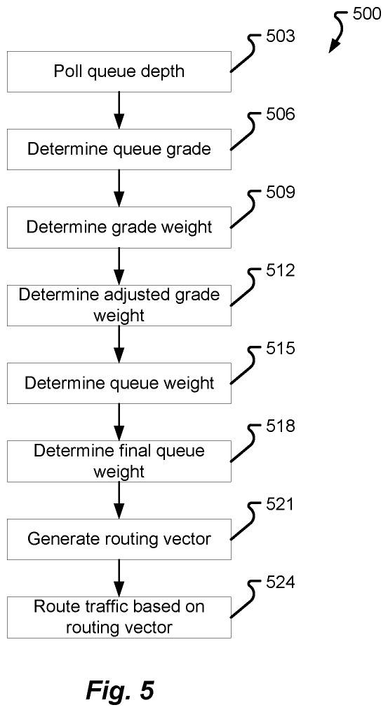

As illustrated in FIG. 5, a method 500 as described herein may be performed by a switch 103 in accordance with one or more of the embodiments described herein. The method 500 involves generating a routing vector and/or mask comprising a weight for each of a plurality of ports. The routing vector or mask is used by switching hardware 109 to route packets to queues 121a-d, where each queue 121a-d is associated with a port 106a-d, and each port 106a-d is associated with one or more destinations or nodes 300 as illustrated in FIG. 3.

While the features of the method 500 are described as being performed by switching hardware 109, it should be appreciated that the functions may be performed by switching hardware 109, a processor 115, or any other computing device in or in communication with a switch 103. The switch 103 comprises a plurality of ports 106a-d. Each port 106a-d is associated with a respective queue 121a-d.

At 503, a queue depth for each queue 121a-d is polled. As described above, polling a queue 121a-d may comprise determining an amount of storage space in the queue 121a-d which is occupied by data, such as packets to be transmitted via a port 106a-d associated with the queue 121a-d, an amount of available space in the queue 121a-d which is not occupied by data, or another indicator as to the current usage of the queue 121a-d. Polling may comprise reading data in each queue 121a-d or may comprise reading memory elsewhere in the switch 103.

At 506, a QueueGrade for each queue 121a-d may be determined. As described above, each queue 121a-d may be associated with a QueueGrade. The QueueGrade may be a quantization which ranges of queue depths may be assigned particular grades. As an example, a grade 1 may indicate queue depths of zero to thirty kilobytes, a grade 2 may indicate queue depths of third to sixty kilobytes, a grade 3 may indicate queue depths of sixty to one hundred kilobytes, a grade 4 may indicate queue depths of one hundred to one hundred and fifty kilobytes, and a grade 5 may indicate queue depths of 150 or more kilobytes.

At 509, a GradeWeight for each queue 121a-d may be determined based on the QueueGrade for each queue 121a-d. As described above, each QueueGrade may be associated with a particular weighting. The GradeWeight of each queue 121a-d may be a numerical or relative value assigned to each queue 121a-d to indicate the odds of the queue 121a-d being chosen to send a next packet. The GradeWeight weightings help to balance the flow of packets based on the queue depth. As described herein, the GradeWeight is but one part of the overall weighting, or the Final QueueWeight.

The GradeWeight of each grade may vary as a function of system settings. For example, a first grade, which may be assigned to queues with relatively low queue depths, may be assigned a higher GradeWeight while a fifth grade, which may be assigned to queues with the highest queue depths, may be assigned a lower GradeWeight. It should be appreciated that the grade numberings used herein are examples only and should not be considered as limiting in any way.

At 512, an AdjustedGradeWeight for each queue 121a-d may be determined using the QueueGrade for each queue, a weight. Determining the AdjustedGradeWeight may be based on the assigned grade of the respective queue. Because the grade of a queue may be associated with a percentage or an amount of available space of the queue, the weight may effectively be determined based on a size of each queue.

Determining the AdjustedGradeWeight for a queue may be performed by assigning the GradeWeight to a queue based on the QueueGrade of the queue. For example, if a queue zero has a QueueGrade of grade one, and grade one has a GradeWeight of 50, then the AdjustedGradeWeight of queue zero may be determined to be 50. In this way, the processor 115, the switching hardware 109, or other component of the switch 103 may map the weight for each grade to each queue based on the grade of the respective queue.

At 515, a QueueWeight for each queue 121a-d may be determined based on factors other than the queue depth. As described above, the QueueWeight may be determined based on data received from a remote peer. For example, the switch 103 may receive information from one or more nodes 300a-f indicating a number of active queues, a level of congestion, or information about another quality associated with a queue of the remote peer which may be used by the switch 103 to assign a QueueWeight for ports leading to the respective node. The switch 103 may receive the information in the form of a packet or a message from each remote peer. The switch 103 may receive the packet or message from the remote peer via one of ports 106a-d as illustrated in FIG. 1, and the packet or message may be received and/or handled by the switching hardware 109 and/or the processor 115.

At 518, a FinalQueueWeight for each queue 121a-d may be determined. As described above, in some implementations, a different weight vector may be generated for each possible destination address and may include only queues for ports which lead to the destination address. For example, the weight vector may be set equal to ValidQueues*FinalQueueWeight or ValidQueues* [CR*QueueWeight+(1−CR)*AdjustedGradeWeight], where ValidQueues is a vector indicating all possible queues.

At 521, a routing vector or mask 406 may be generated. As described above, in some implementations, a different routing vector or mask 406 may be generated for each node 300a-f or destination address for which packets may potentially be addressed. As described above, the queue vector mask 406 may represent each queue by a multi-bit binary number (e.g., a queue may be represented by one of 0000, 0001, 0011, 0111, 1111). As an example, if a first port 106a is weighted so as to not receive any additional packet, the first port 106a may be represented by a logical zero (0) in each bit of its multi-bit binary number. If each queue is represented by four bits, the first port 106a may be represented by 0000. In this way, the data is routed to the first queue by performing a round robin selection of the first queue based on weights associated with the determined queue grade of each queue.

At 524, traffic, such as a packet, may be routed based on the routing vector or mask 406. As described above, the switching hardware 109 may perform round-robin by writing a packet to a next logical one (1) in the queue vector mask 406. If the queue vector mask 406 for a

switch with four egress ports 106a-d is [0000] [0001] [0011] [0111], then the switching hardware 109 may perform round robin by routing a first packet to a second port 106b, second and third packets to a third port 106c, and fourth through sixth packets to a fourth port 106d.

As an example, consider switching hardware 109 tasked with distributing a flow of packets among four egress ports 106a-d, with each port 106a-d associated with a different queue 121a-d. A first queue 121a may be assigned a weight of four, a second queue 121b a weight of three, a third queue 121c a weight of two, and a fourth queue 121d a weight of one. The total weight of all queues 121a-d is ten.

The switching hardware 109 will use the weights to distribute each packet 403. The proportion of packets sent to a given port is equal to the weight of that port divided by the total weight. As a result, for every ten packets, the first queue 121a may receive, on average, four packets, the second queue 121b three packets, the third queue 121c two packets, and the fourth queue 121d one packet. In this way, the switching hardware 109 may be enabled to distribute the packet flow according to the weightings of each queue, ensuring that each port gets its share of the traffic. This kind of weighted distribution enables load balancing and routing in computer networking, where it helps to optimize network performance and efficiency.

As packets 403 are routed to queues 121a-d, the queue depth may change. Over time, additional information may be received from nodes 300. The processor 115 or switching hardware 109 may continuously or periodically update the weight of each queue 121a-d and a new queue vector mask 406 may be created. As a result, the percentage of packets being sent to a particular queue 121a-d may constantly be changing to account for the amount of data in each queue and/or events occurring at remote nodes 300.

In one or more embodiments of the present disclosure, the method 500, after executing, may return to 503 and recommence the process. In some implementations, the repetition of method 500 may occur without delay. In such cases, as soon as the method 500 concludes, the method 500 may immediately begin the next iteration. This arrangement could allow for a continuous execution of method 500. In some implementations, a pause for a predetermined amount of time may occur between successive iterations of method 500. The duration of the pause may be specified as per the operational needs of the method such as by a user.

The present disclosure encompasses methods with fewer than all of the steps identified in FIG. 5 (and the corresponding description of the method), as well as methods that include additional steps beyond those identified in FIG. 5 (and the corresponding description of the method). The present disclosure also encompasses methods that comprise one or more steps from the methods described herein, and one or more steps from any other method described herein.

Embodiments of the present disclosure include a system to route data to one of a plurality of queues, the system comprising: a processor to: poll a depth of one or more queues of the plurality of queues; determine a weight for each polled queue based on the depth of each polled queue; and route data received via a port to a first queue of the plurality of queues based on the determined weight for each polled queue.

Embodiments of the present disclosure also include a computing system comprising one or more circuits to: determine an amount of data stored in each queue of a plurality of queues; determine a weight for each queue based on the data stored in each queue; and generate a routing instruction based on the determined weight for each queue, wherein data received by the computing system is routed to a first queue of the plurality of queues based on the routing instruction.

Embodiments of the present disclosure also include a switch comprising one or more circuits to: determine an amount of available space in each queue of a plurality of queues; determine a weight for each queue based on the amount of available space in each queue; and generate a routing instruction based on the determined weight for each queue, wherein data received by the switch is routed to a first queue of the plurality of queues based on the routing instruction.

Aspects of the above device, computing system, and/or switch include wherein the depth of each polled queue is stored periodically in a database.

Aspects of the above device, computing system, and/or switch include wherein each of the one or more queues of the plurality of queues is associated with an egress port.

Aspects of the above device, computing system, and/or switch include wherein the depth is polled periodically or continuously.

Aspects of the above device, computing system, and/or switch include assigning each polled queue a grade based on one of a percentage or an amount of occupied or available space of each respective queue, and wherein determining the weight for each polled queue is based on the assigned grade of the respective queue.

Aspects of the above device, computing system, and/or switch include wherein the weight is determined further based on a size of each polled queue.

Aspects of the above device, computing system, and/or switch include wherein the data is a packet received from one or more ingress ports.

Aspects of the above device, computing system, and/or switch include wherein the system comprises a switch, and wherein routing the data comprises balancing traffic of the switch by routing the packet from one of the ingress ports to the first queue based on the determined weight for each polled queue.

Aspects of the above device, computing system, and/or switch include a counter, wherein the counter is used to determine how many bytes are sent to each port.

Aspects of the above device, computing system, and/or switch include wherein routing the data to the first queue is further based on a value of the counter.

Aspects of the above device, computing system, and/or switch include updating the weight for the one or more queues based on the value of the counter.

Aspects of the above device, computing system, and/or switch include wherein routing the data to the first queue is further based on a score associated with remote link failures.

Aspects of the above device, computing system, and/or switch include wherein the score associated with remote link failures is determined based on data received from a remote peer.

Aspects of the above device, computing system, and/or switch include wherein the data received from the remote peer indicates a quality associated with a queue associated with a destination of the data.

Aspects of the above device, computing system, and/or switch include wherein routing the data to the first queue is based on the determined weight of each polled queue, a counter value indicating a size of previous data sent to each queue, and data from a remote peer indicating a quality associated with a remote link between the remote peer and a destination of the data.

Aspects of the above device, computing system, and/or switch include averaging each of the determined weight for each queue, the counter value, and the data from the remote peer.

Aspects of the above device, computing system, and/or switch include wherein the data is routed to the first queue by performing a round robin selection of the first queue based on grades associated with the determined weight for each queue.

Aspects of the above device, computing system, and/or switch include wherein the data is routed to the first queue by randomly selecting the first queue based on grades associated with the determined weight for each queue.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system to route data to one of a plurality of queues, the system comprising:
a processor to:
poll a depth of one or more queues of the plurality of queues;
determine a weight for each polled queue based on the depth of each polled queue; and
route data received via a port to a first queue of the plurality of queues based on the determined weight for each polled queue.

2. The system of claim 1, wherein the depth of each polled queue is stored periodically in a database.

3. The system of claim 1, wherein each of the one or more queues of the plurality of queues is associated with an egress port.

4. The system of claim 1, wherein the depth is polled periodically or continuously.

5. The system of claim 1, further comprising assigning each polled queue a grade based on one of a percentage or an amount of occupied or available space of each respective queue, and wherein determining the weight for each polled queue is based on the assigned grade of the respective queue.

6. The system of claim 1, wherein the weight is determined further based on a size of each polled queue.

7. The system of claim 1, wherein the data is a packet received from one or more ingress ports.

8. The system of claim 7, wherein the system comprises a switch, and wherein routing the data comprises balancing traffic of the switch by routing the packet from one of the ingress ports to the first queue based on the determined weight for each polled queue.

9. The system of claim 1, further comprising a counter, wherein the counter is used to determine how many bytes are sent to each port.

10. The system of claim 9, wherein routing the data to the first queue is further based on a value of the counter.

11. The system of claim 10, further comprising updating the weight for the one or more queues based on the value of the counter.

12. The system of claim 1, wherein routing the data to the first queue is further based on a score associated with remote link failures.

13. The system of claim 12, wherein the score associated with remote link failures is determined based on data received from a remote peer.

14. The system of claim 13, wherein the data received from the remote peer indicates a quality associated with a queue associated with a destination of the data.

15. The system of claim 1, wherein routing the data to the first queue is based on the determined weight of each polled queue, a counter value indicating a size of previous data sent to each queue, and data from a remote peer indicating a quality associated with a remote link between the remote peer and a destination of the data.

16. The system of claim 15, further comprising averaging each of the determined weights for each queue, the counter value, and the data from the remote peer.

17. The system of claim 15, wherein the data is routed to the first queue by performing a round robin selection of the first queue based on grades associated with the determined weight for each queue.

18. The system of claim 15, wherein the data is routed to the first queue by randomly selecting the first queue based on grades associated with the determined weight for each queue.

19. A computing system comprising one or more circuits to:
determine an amount of data stored in each queue of a plurality of queues;
determine a weight for each queue based on the data stored in each queue; and
generate a routing instruction based on the determined weight for each queue, wherein data received by the computing system is routed to a first queue of the plurality of queues based on the routing instruction.

20. A switch comprising one or more circuits to:
determine an amount of available space in each queue of a plurality of queues;
determine a weight for each queue based on the amount of available space in each queue; and
generate a routing instruction based on the determined weight for each queue, wherein data received by the switch is routed to a first queue of the plurality of queues based on the routing instruction.
